(19) United States
(12) Patent Application Publication
(10) Pub. No.: US 2023/0264225 A1
(43) Pub. Date: Aug. 24, 2023

(54) LIQUID DISPERSION METHOD, OR LIQUID DISCHARGING OR APPLYING METHOD, OR DEVICE THEREFOR

(71) Applicant: MTEK-SMART CORPORATION, Yokohama-Shi, Kanagawa (JP)

(72) Inventor: Masafumi MATSUNAGA, Yokohama-Shi (JP)

(73) Assignee: MTEK-SMART CORPORATION, Yokohama-Shi, Kanagawa (JP)

(21) Appl. No.: 18/001,508

(22) PCT Filed: Jun. 3, 2021
(86) PCT No.: PCT/JP2021/021197

§ 371 Date: Dec. 12, 2022

(30) Foreign Application Priority Data
Jun. 12, 2020 (JP) 2020-101981

(51) Int. Cl. B05C 11/10; B05C 5/00; B05D 3/00

(52) U.S. Cl. CPC B05C 11/1034; B05C 5/00; B05D 3/00

(57) ABSTRACT

A preliminary container upstream of a slurry container, a tube or pipe of a compressed air discharge line from the slurry container is inserted into the preliminary container, so that, even if a slurry flows back, the slurry is retained in the preliminary container and the slurry is prevented from flowing back upstream of the preliminary container. In addition, minute droplets are prevented from flowing back upstream, by using a protector, or an air-permeable screen.

### TECHNICAL FIELD

The present invention relates to a method or a device for discharging or coating uniformly-dispersed slurries, dispersions, and the like (e.g., adhesives that are liquid at normal temperature, coating agents, liquid chemicals, especially liquid containing solid particles and short fibers, etc.), or thermally melted bodies that flow in liquid form when heated. For example, the thermally melted bodies that are melted in liquid form when heated, such as resins that are solid at normal temperature including a paraffin wax having low viscosity, moisture-curable type polyurethane hotmelt (PUR)-based pasty thermoplastic resins, and metals having a low viscosity and a low melting point such as solder, can be preferably used in the present invention. The thermally melted body may contain functional particles, short fibers, and the like. In this case, a liquid-shaped flow behavior of the thermally melted body is generally similar to that of slurry. For this reason, in the present invention, the thermally melted body will also be defined as liquid hereinafter.

A part of the device, which is in contact with the thermally melted body, needs to be heated to put the thermally melted body in a liquid state. In the present invention, discharging or coating liquid is releasing desired droplets from a nozzle or the like that is an outlet of liquid, as with an inkjet or a dispenser, and includes spraying for granulation and encapsulation of drugs, foods, fertilizers, and the like. The released droplets may adhere to an object, and can also be sprayed toward a fluidized bed formed by releasing gas toward an entire surface (e.g., a fluidized bed formed by a hot air flow, etc.) to coat or spray-dry tablets for granulation. Particle generation does not depend on a discharging method such as an inkjet, a dispenser, an airless spray, a two-fluid spray, a rotary atomizing method, and the like. A coating device includes a slot nozzle coating and a slit nozzle coating for purposes other than those described above. It also includes a method for generating particles with a fine particle generator by applying this device. A topical coating to an object such as a substrate, a dispersive coating that is to coat scattered particles onto a surface, and a coating along with combining spray particles to each other to form a film in a plane shape are cited as examples. A method for generating the fine particles that are smaller than spray particles and coating them on the substrate sparsely, or forming a thin film in a plane shape by laminating fine particles and by combining the particles on an object may be adopted. It also includes a micro curtain coating, which is to coat from airless spray nozzle to an object a desired liquid film formed by relatively low pressure of around 200 to 600 kPa, and a bead coating in an elongated linear shape with a dispenser nozzle may also be performed. It may also be a coating using the slot nozzle or the like, which is a continuous or intermittent coating on the surface of the substrate in a desired pattern onto an object that is relatively moving continuously or intermittently.

### BACKGROUND

Conventionally, solid particles in liquid such as slurry tend to be sedimented, and the slurry in a container tank was suctioned, pressure-fed, and circulated in a large quantity by a pump so that an object was coated by discharging or spraying the slurry from a coating head provided in a middle of a circulation circuit, or doing things like that. Meanwhile, in Patent Literature 1 that discloses a method invented by the inventors of the present invention, a slurry was coated dispersedly to an object on a condition that slurries inside syringes were pressurized by a compressed air in a coating device among two or more syringes and were transferred among a plurality of syringes while controlling a flow rate with a flow rate limiting member.

### PATENT LITERATURE

[Patent Literature 1] JP-A-2003-300000

### SUMMARY

However, in the former method, a device was enlarged to fill a large container such as a tank with a large amount of liquid such as slurry, thereby leading to a need for a large amount of slurry and the like. For this reason, an initial investment and a large amount of wasted material were needed for an application of a table test material to confirm an initial performance of a functional material, especially for granulation or encapsulation for reagents.

Meanwhile, in above-mentioned Patent Literature 1 in which the inventors of the present invention disclose even a small amount of material can be used, a slurry of one of the containers stored in at least one of two or more syringes is pressurized by a compressed air, and an air line for pressurizing material in the other container is opened to communicate the one of the containers to the other container through a liquid flow passage for liquid transfer, and then liquid such as slurry is transferred or discharged while being transferred by providing an automatic discharging device near a middle of the flow passage. By repeating this action alternately, a coating was able to be conducted while preventing to some extent, for example, sedimentation of solid particles of a catalyst slurry for electrodes of a fuel cell, the solid particles composed of nano-order particles. However, since sedimentation occurs if an average particle diameter is relatively large (e.g., submicron to nearly 20 µm), a flow velocity was increased by increasing pressure to prevent sedimentation, resulting in a frequent occurrence of backflows to upper streams of the containers. Further, the present invention is applicable to a method for transferring liquid such slurry through a flow passage while adding bubbles to the liquid, the method invented by the inventors of the present invention and disclosed in JP-A-2018-107355.

For example, as for electrodes of a lithium-ion secondary battery (hereinafter referred to as LIB) and an all-solid battery which has been paid attention to in recent years, sulfide-based solid electrolyte particles have a high performance and therefore are strongly desired to be deployed into markets. On the other hand, since a slurry for electrode contains active material particles, electrolyte particles, conductive auxiliaries such as carbon nanotubes and carbon nanofibers that easily aggregate, solvents, and binders, it was almost impossible to conduct coating while uniformly dispersing them and improving application performance. Also, since humidity control is a big problem for sulfide-based solid electrolyte particles, a large capital investment is needed, and at least a problem for a coating operation was needed to be resolved certainly. For the sulfide-based solid electrolyte particles, a device such as a glove box (hereinafter referred to as GB) is generally installed in a dry room at a temperature of minus 30 to 50° C., operations in GB and the like were mandatory to improve an electrode performance, and an environment in GB at a temperature of minus 70 to 90° C. where a dew point is much lower was needed. Further, GB was needed to be filled with inert gas such as argon gas. For this reason, since a temperature of pressurized gas was needed to be lowered to minus 50° C. or below, or minus 80° C. or below in a case of using compressed air, inert gas, or the like to pressurize liquid in a container, high initial costs were required. Incidentally, ternary active materials such as NMC are used for slurries for positive electrodes of LIBs and all-solid batteries, and polyvinylidene fluoride (hereinafter referred to as PVDF) having durability over electrolyte solutions, heat, and chemicals is particularly used for binders of lithium-ion secondary batteries. Thus, normal methyl pyrrolidone (hereinafter referred to as NMP), which can dissolve PVDF, is often used as a solvent. However, it is said that it is preferred that there is no PVDF in a binder in extreme cases since it is an insulator. However, it is needed as an adhesion component of electrode particles, and a weight ratio thereof to a total weight of all solids of the electrode needs to be as low as possible, for example 10 wt.% or less, preferably 5 wt.% or less, and more preferably 3 wt.% or less. In a case that an electrode slurry was coated to an object such as an aluminum foil of a collector, for example, with a spray or slot nozzle, it was difficult to obtain a desired thick film since NMP has a high boiling point of 200° C. or more and NMP in a coated film formed by thickly coating a layer of a slurry is less likely to evaporate. A crack and the like were generated when forming a thick film for one time, for example, when coating a slurry to form an electrode having a post-dried thickness of 100 µm or more. On the other hand, for LIBs, precipitation occurred even in aqueous slurries using carbon and silicon particles that are active materials of a negative electrode and rubber-based SBR which is a binder, when a viscosity of the slurry was low. A collector of a negative electrode is generally made of copper foil or stainless-steel foil. In the present invention, a collector may be made of a resin, and the material, shape, and the like are not particularly limited. Also, since moisture is not acceptable in a case of all-solid batteries, for a negative electrode, NMP was needed to be used as a solvent when PVDF was used as a binder. SBR (styrene butadiene rubber), which is a binder often used in secondary batteries for a negative electrode, can be dissolved with organic solvents as well.

To enhance volatilization of a high-boiling solvent in a slurry, a solvent having a lower boiling point is generally added to dilute a slurry, which is expected to cause an azeotropic phenomenon. However, the only solvents that can dissolve PVDF are poor solvents because it is difficult to dissolve PVDF in good solvents having medium or low boiling points, other than high boiling point NMP, DMF and the like. In the present invention, a high boiling point, a medium boiling point, and a low boiling point are defined as 200° C. or above, 150° C. or below, and 100° C. or below, respectively. It is difficult to dissolve PVDF in solvents having medium or low boiling points, and in particular, only poor solvents were found available among PRTR-free products which are also standards for industrial use.

For this reason, when in a slurry of the present invention a ratio of solvent to solids is higher and viscosity is lower, the solvent is desired to volatilize at a desired speed after coating with a spray nozzle or a slot nozzle for coating to an object at a lower stream of a discharging device, and a mixed solvent is desired. In particular, it was ideal to add a low boiling point solvent and to used azeotropy. In addition, heating an object is a good way to quickly volatilize a solvent in a slurry after coating to an object. If a low boiling point solvent cannot be used, of course, in addition to heating the object, it is better to spray a slurry to speed up volatilization as much as possible, and ideally it is better to spray a slurry in pulses, which reduce a density of sprayed particles per unit time or per unit space volume, to increase particle sizes and a surface area of the slurry, which is preferred to increase contact with an atmosphere and promote solvent volatilization. Among sprays, a two-fluid spray (air spray) method, in which a compressed gas is used to form particles, or a pulsed spray method thereof, is even better because a gas having 200 to 600 times by mass of spray particles, which is near spray particles, moves through an atmosphere concurrently with the spray particles while breaking through the atmosphere, further increasing contact opportunities. Further, to obtain a synergistic effect of heating and spraying the object at 40 to 120° C. in terms of promoting solvent volatilization, smaller particle sizes are preferred. Low viscosity is preferred because splayed particle sizes can be reduced, atomization can be promoted, and the surface area can further be increased. Under the condition, solid content should be reduced to, for example, about 25% or less because the solvent can be quickly volatilized on the heated object, and more NMP should be added to reduce viscosity such that the viscosity is reduced and the binder dissolves completely, although it is a high boiling point solvent. This enables to lower a splay weight per unit area per a layer and to coat a thin film. Therefore, to obtain a target dry coating weight per unit area on the object, multiple layers are available and can be stacked with the desired number of layers. In particular, a method for heating the object while suctioning it with a vacuum is effective because there is almost no insulation layer of air between a heating section and the object, keeping the object heated while preventing the object from being cooled by vaporization heat of the solvent. Therefore, the object is preferred to be heated while being suctioned by a heated sucking table, a heated sucking drum, or a heated sucking belt. However, lowering the viscosity caused severe sedimentation of solid particles over time, and it was necessary to raise the flow velocity of the slurry in the flow passage or the container as much as possible to uniformly disperse, in particular, each particle and short fiber of the all-solid battery. In particular, the higher the flow velocity in the container, the faster the speed of the jets and droplets was when using the method disclosed in the reference and the others, and sometimes the liquid flowed back out of the container. Even when an upper limit detection system of liquid was set, a backflow frequently occurred at a speed such that switching control could not follow, damaging an automatic switching valve and the like at an upper stream of a compressed air line. Furthermore, when a gas was mixed into liquid such as slurry due to jets, the mixing was further intensified, and liquid turned into droplets due to rupture caused by a mixture of a compressed gas having a large and unstable diameter, further accelerating a backflow. For this reason, it was necessary to resolve them.

On the other hand, in fields of LIB electrode formation, ceramics coating on separators, and electrode and electrolyte layer formation in all-solid batteries, mild solvents are ideal, especially when azeotropy is expected, so normal heptane is cited as one of candidates. NMP, which is a solvent having affinity to the above mentioned PVDF, has a specific gravity of about 1, whereas a specific gravity of normal heptane (hereinafter referred to as heptane), which is a PRTR-free product and has a low boiling point, is 0.8 or less. It can be made into a slurry by mixing, stirring, and dispersing PVDF binder solution dissolved in NMP, solid particles or short fibers of active materials and conductive auxiliaries, and the like, and NMP as a diluting solvent. If heptane, which is a poor solvent, is added to the mixture and processed by a dispersion device (e.g., processed by high-speed agitation), a superficial good dispersion can be achieved. However, when agitation is stopped, the poor solvent separates instantaneously. In addition, when the syringes of the present invention are filled with it, a phenomenon occurs such that a slurry consisting of NMP solvent and solids at lower parts of left and right syringes forms a layer with the poor solvent floating on the top of the slurry. To eliminate separation of good and poor solvents and achieve a uniform mixing, it was necessary to increase a flow velocity of the slurry in the container during transfer and generate a jet flow to generate intense turbulence in the slurry and others to improve a dispersion effect. For this reason, it was necessary to increase the flow velocity of the liquid in the flow passage and the container.

Dispersion, or mixing and dispersion can be improved by adding a static mixer and the like, which can be installed in a lower part of the container (liquid inlet/outlet), in a liquid flow passage, or inside the liquid container as desired if necessary. In particular, mixing and dispersion performed with a dynamic mixer by power may be employed. Furthermore, it is also possible that the liquid in one of the containers is pressurized with a compressed gas and the pressure inside the other container is set to either a lower pressure that is a negative or positive pressure, or an atmospheric pressure, to move the liquid through a flow passage or a discharging device, the liquid level of the other container is controlled to a desired level, and the mixer is provided inside a piping upstream or downstream of a pump that pumps up the other liquid to move it to the one of the containers. Furthermore, in the present invention, a dispersion state of slurry and the like can be improved by efficiently mixing small bubbles into a circulating slurry and the like by mixing microbubbles downstream of pump or in the flow passage leading to the discharging device. Besides, a device itself can be made compact or ultra-compact by using a dispersion method based mainly on a collisional mixing or a collisional dispersion, the method invented by the inventors of the present invention and disclosed in Patent Literatures such as JP-A-Sho63-242332, JP-A-Sho63-248423, JP-A-Sho63-278534, JP-A-Sho63-296859, and JP-A-Hei01-067232. Therefore, it should be adopted as a compact precise dispersing and discharging device or a coating device for discharging or coating liquid such as slurry. In the present invention, especially when switching a direction of a fluid in the flow passage between containers, it is possible to provide means such as largely swirling liquid, moving liquid by largely generating turbulent flow, and generating a large jet stream near the liquid outlet at the bottom of the container, since the liquid surface level is low and the weight of the liquid is small. A slurry and the like can be transferred while being dispersed by a large spiral flow generated when flowing into the container, which is generated by applying, for example, spiral processing or the like to the flow passage, the dispersion generator, or the dispersing means. For this reason, the smaller the amount of liquid filled into the container, the better the state of mixing and dispersion that can be achieved by jetting all the liquid or the like. For example, a large jet and the turbulence thereof are similar to a behavior of water that hit obstacles such as rocks. An agitating device (e.g., a device to rotate blades and the like) can be provided separately in a medium to large container having a volume of 500 mL or more and further a large diameter.

Usually, these small containers or containers that are called syringes are desired to have a volume of around 50 mL to 10 L. Of course, the volume may be 10 L or more, 50 mL or less, or 20 mL or less. In a case that the volume is 70 mL or less, the flow passage may be a hole processed on a discharging device structure or a metal piping, and may be formed by connecting inlet and outlet of the container with a metal piping or a tube piping such as PFA. If the container is not much larger than 0.2 L and the viscosity is 500 mPa s or less, the flow velocity of slurry and the like may be increased by setting an average inner diameter of a piping such as a PFA tube for a coating head to 4 mm or less, preferably 2.5 mm or less. Apart from that, a length of the flow passage between containers may be, for example, 6 meters at the longest, due to the device structure. However, if possible, it may be, for example, 1 meter or shorter, preferably 300 mm or shorter in a case of small containers, which is achieved by reducing the length between containers.

The volume of the container may be 3 L, 10 L, or more, but a diameter of the flow passage should be as large as desired in relation to the length. It is possible that two containers are connected via a tube having an average inner diameter of 4 mm or more in a case that a liquid filling volume into at least one of the containers exceeds 1 L or a piping such as a tube preferably having an inner diameter of 6 mm or more, which is not a flow passage of a discharging device, in a case that the liquid filling volume in the container exceeds 3 L, by which high speed transfer or mass transfer of liquid such as slurry is performed to prevent sedimentation of slurry, and viscosity is lowered by shearing force of the slurry in a short time, thereby enabling coating in a desired stable viscosity range. An inner diameter of a piping such as these tubes can be large regardless of a piping of a discharging device, the overall length can be shortened, and the piping can be pluralized, regardless of the size of the inner diameter. One piping, or two or more multiple piping means may be used as a tube piping of a discharging device. For example, if two pipings are used, a structure, which allows collision dispersion at a confluence by merging two pipings into one and by transferring liquid at a high speed inside or outside a discharging device, may be used. Furthermore, other dispersing means or flow regulating means may be provided in a pathway. In addition to the flow passage to the discharging device and the like, a flow passage to increase an amount of liquid transfer as described above can be provided separately. It is better that the flow passage is leading from a bottom of the container, and it is a piping. The flow passage leading from the bottom of the container may be single or multiple, and a flow passage can be branched into multiple flow passages. The average diameter of the flow passage can be larger than that of the discharging device, which may be, for example, twofold or threefold, and flow adjustment means can also be provided.

The present invention is to pressurize liquid such as slurry in at least one of the containers with a compressed gas or the like, and to make pressure in the other containers into an atmospheric pressure, thereby generating a differential pressure among the containers and transferring the liquid into the other containers at high speed. Liquid may be transferred alternately between the two containers. The pressure of the container filled with liquid can be high or low and is not limited, but may be less than 200 kPa or lower considering an economic cost of the container, the piping, and the like. If liquid can be transferred at high speed, one of the containers connected to an atmospheric pressure may be depressurized to a negative pressure or pressurized to a positive pressure. Considering costs, in a case of using two containers, it is enough that the pressure in at least one of the containers is set to an atmospheric pressure and the other container is pressurized by a compressed air and the like. The exhaust port of the gas switching valve is connected with the exhaust port of a coating booth to suction and remove solvent and the like in which a small amount of liquid is evaporated. If there are two containers, it is enough that each level at the bottom of each container is detected by a sensor or the like, and pressurizing the container and operating an automatic switching valve of a circuit leading to an atmospheric pressure are executed alternately and automatically. Using a 4-way valve (3-way valve excluding a pilot port) is enough if two automatic switching valves are used for each container, and a valve having 4 or more ports can be used if the containers share the valve. The present invention is to improve as much as possible the state of mixing and dispersion of liquid such as slurry consisting of solid particles, especially micron-order particles that are relatively large and have high specific gravity, and a solvent, or consisting of solid particles, a small amount of binder, and a solvent, and dispersion that is incompatible with solvents and difficult to disperse well; to make them uniform when discharging liquid; to quickly make the viscosity range constant by imparting a shearing force to liquid by transferring liquid at a higher speed for lowering the viscosity and to discharge liquid; to obtain a stable discharge volume per unit time using a discharging device and the like; to further make a coating amount per unit time constant and make uniform a film thickness at a desired position on an object. Therefore, the desired positive side pressure of moving liquid needs to be as high as possible to increase a flow velocity and achieve a constant pressure range.

Recently, the development of therapeutic drugs for COVID-19 or the like, which is a major global issue, has been proceeding at a rapid pace. However, the volume required at the laboratory level for the purpose of material development for granulation and encapsulation of pharmaceuticals is only a few ml to 20 ml, making a large equipment unsuitable for this purpose and requiring significant expense for material development.

Recently, the development of the agents and functional coating materials has progressed, and expensive materials have been increasing. The materials include dispersions containing particles having a particle size distribution of less than a few micrometers or in the order of nanometer in some cases; powder slurries containing particles such as polymers; and electrode inks for fuel cell electrodes and electrode inks with nanometer-order platinum ultrafine particles supported on carbon nanotubes that are proposed in US-B-5415888 and others. Since 1 kg of an electrocatalyst ingot costs several million yen or more, further costs are needed for further nanosizing the ingot. For this reason, in addition to being able to form high quality, high performance electrodes, a device and a method that enables to use a minimum amount of coating material without waste is intensely desired. However, when the viscosity of the liquid is low, the container is small, the liquid filling volume is small, and the compressed air pressure is high, the liquid transfer is switched to the other side instantly and sometimes the slurry or the like adheres further to the transparent container such as PFA or PP, the optical sensor and the like is made unable to detect it, a backflow of liquid out of the container on the other side also occurs due to switching failure, by which valuable and expensive materials are often wasted in addition to issues such as damages of automatic switching valves. In a method such that the upper level of liquid at the upper part of the container is detected for controlling, it was difficult to prevent a backflow, since, for example, a speed of a backflow where compressed gas was mixed could not be handled.

The present invention was invented in view of the above-mentioned problems and is to provide a method and a device for discharging a minimum amount of liquid that can be handled without waste and discharged or sprayed in an accurate amount without causing solid particles to settle, and a method and a device for coating liquid to an object. The basic data can be applied to mass production, and using large containers enables high speed mass production. Any form of a discharging or coating device, or the like, and any type of a discharging or coating device, a dispenser, an inkjet, a spray, a slot nozzle, and the like may be used.

The specific purpose of the present invention is to provide a method and a device for suitably dispersing liquid such as slurries and dispersions, which are particularly prone to settle or have dispersion issues, and for stabilizing discharging and coating. Battery materials, especially catalyst inks for fuel cells, slurries for electrodes of secondary batteries and all solid batteries, slurries for electrolytes, and the like can be pressurized with a compressed gas and discharged. Since the electrode slurry for fuel cells contains platinum catalysts and the like that can catalytically ignite, there should be no backflow into the upper stream of the container, but it is necessary to increase the flow velocity in the flow passage or in the container to improve dispersion. In the present invention, the PUR and anaerobic materials such as anaerobic adhesives, which dislike moisture, can be handled in the booth under a dehumidified atmosphere without problems, as in the case with all-solid batteries. The method invented by the inventors of the present invention, which is disclosed in JP-A-2013-144279, can be used concurrently to check the accurate coating weight, and a high-performance end product can be manufactured by calibration on an as-needed basis.

In the present invention, the liquid discharging method and device to solve the above-mentioned problems will be explained in the following.

This invention has an advantage that the same process can be used in a case of using an extremely small amount of slurry and dispersion that are difficult to handle, or in a case of developmental manufacturing on a large scale.

The present invention is as follows.

The present invention is a method for discharging liquid, dispersing the liquid or discharging or coating the liquid by using a device for discharging or coating the liquid, or a device therefor, the method including
providing the device for discharging or coating the liquid among at least two containers,
communicating the containers with the device for discharging or coating the liquid via a liquid flow passage,
pressurizing the liquid filled in at least one of the containers to generate a differential pressure between the one of the containers and another container,
transferring the liquid in the flow passage,
reversing the differential pressure between the containers near a lower limit of liquid surface in the one of the containers to perform inverted transfer of the liquid between the containers automatically and repeatedly, and
providing a reserve container having a larger volume than at least a total volume of the liquid at an upper stream of each of the containers to store in the reserve container the liquid that flows back to a reserve container for preventing a backflow of the liquid or droplets of the liquid to an upper stream of the reserve container.

The present invention provides the method for discharging liquid, dispersing the liquid or discharging or coating the liquid, or the device therefor, the method including
extending compressed gas flow passages into both the containers via lids,
connecting liquid flow passage pipings to the lids,
inverting the containers after the container lids are removed and filled with the liquid,
positioning each outlet of the compressed gas flow passages upstream of each liquid surface,
pushing out the liquid inside the compressed gas flow passages,
pressurizing the liquid coming from the outlet of the compressed gas flow passages by a compressed gas, and
transferring the liquid by a pressure of the compressed gas via the liquid flow passages from one of the containers to the other container.

The present invention is the method for discharging liquid, dispersing the liquid or discharging or coating the liquid, or the device therefor, the method including
pressurizing the liquid in the container by the compressed gas,
providing a switching valve having an inflow port and an exhaust port of the compressed gas upstream of the reserve container,
connecting a piping for the compressed gas to make the compressed gas exhaust enter the reserve container via an upper part of the container and an upper part of the reserve container and
connecting the piping from a compressed gas inlet or outlet provided at another position on the upper part of the reserve container to the automatic switching valve for the compressed gas.

The present invention is the method for discharging liquid, dispersing the liquid or discharging or coating the liquid, or the device therefor, the method including
detecting a lower limit of a liquid level at a lower part of the container on a side in which the liquid descends,
increasing at least a flow velocity in the liquid flow passage,
controlling the level to repeat liquid transfer near the lower limit of the liquid level of the container and reverse the container automatically, and
generating a swirling flow or jet of the liquid in the lower part of the container on a side in which the liquid flows in, at least in switching the liquid transfer, to improve liquid dispersion.

The present invention is the method for discharging liquid, dispersing the liquid or discharging or coating the liquid, or the device therefor, the method including
setting an average diameter of the liquid flow passage between the containers to 1.5 to 4.0 mm, and
setting a liquid speed inside the flow passage to 0.4 m/s or more.

The present invention is the method for discharging liquid, dispersing the liquid or discharging or coating the liquid, or the device therefor, the method including
filling the container with the slurry or dispersion having a low viscosity of 500 mPa s or less as the liquid, the container having the lower part that is invertedly widened, bowl-shaped, or in a similar shape, and
generating the swirling flow or jet of the liquid in switching transfer between the containers.

The present invention provides the method for discharging liquid, dispersing the liquid or discharging or coating the liquid, or the device therefor, the method including

floating a ball on the liquid surface to prevent at least droplets generated by the swirling flow or jet from flowing back to the compressed gas passage at the upper part of the container.

The present invention provides the method for discharging liquid, dispersing the liquid or discharging or coating the liquid, or the device therefor, the method including
providing the device for discharging or coating the liquid among at least two containers,
communicating the containers with the device for discharging or coating the liquid via a liquid flow passage,
pressurizing the liquid filled in at least one of the containers to generate a differential pressure between the one of the containers and another container,
transferring the liquid in the flow passage,
reversing the differential pressure between the containers near a lower limit of liquid surface in the one of the containers to perform inverted transfer of the liquid between the containers automatically and repeatedly,
putting a total volume of the liquid equal to or smaller than an internal volume of the one of the containers,
providing a protector at a compressed gas inlet port on the upper part of the container to intrude into the container, the protector having breathability at least partially and blocking the liquid transfer, and
preventing the liquid or droplets from flowing back by the protector.

The present invention is a method for discharging liquid, dispersing the liquid or discharging or coating the liquid, or a device therefor, the method including
providing the device for discharging or coating the liquid among at least two containers,
communicating the containers with the device for discharging or coating the liquid via a liquid flow passage,
pressurizing the liquid filled in at least one of the containers to generate a differential pressure between the one of the containers and another container,
transferring the liquid in the flow passage,
reversing the differential pressure between the containers near a lower limit of liquid surface in the one of the containers to perform inverted transfer of the liquid between the containers automatically and repeatedly, and
increasing a transfer speed of the liquid in the container by providing another passage such that a flow rate therein is higher than that in the flow passage.

The present invention is a method for discharging liquid, dispersing the liquid or discharging or coating the liquid, or a device therefor, the method including
pressurizing at least one of containers with a compressed gas,
pressuring liquid filled in one of the containers to transfer the liquid via a plurality of liquid flow passages to the other container in which a pressure is lower than an atmospheric pressure or a pressure in the other container,
detecting liquid levels of the both containers,
suctioning and pressurizing the liquid in the other container by pump to form a circulatory circuit by putting the liquid back to the one of the containers,
increasing a liquid transfer speed, and
maintaining at least a liquid pressure of the discharging device constant at any time.

In the present invention, two or more containers may be, for example, three or more, but two containers will be explained. In particular, in a case of using the above-described pump, the other container may be smaller than the one of the containers. The present invention is to prevent jets or droplets of liquid filled in the container from flowing back to the automatic switching valve, provided that a liquid speed in the flow passage or in both containers is increased to generate turbulence, jets, and swirling flows and to disperse liquid such as slurry.

In short, the present invention is to increase the liquid speed in the flow passage or in the container to improve liquid dispersion and to install a container having a volume larger than the total volume of liquid filled at the upper stream of each container, even if the liquid flows back. Furthermore, the reserve container is made have a structure in which the liquid that flowed back is stored but the liquid and the droplet thereof do not flow back to the upper stream. Thus, piping and the like at the upper stream of the liquid in the reserve container can be reused without contamination. Besides, the present invention is to install a protector at the upper part of the container for preventing a backflow, and to not fill liquid having a volume larger than that of the other container. Liquid should be filled with a cup having a volume smaller than that. The present invention is also to obtain a desired distribution of multiple materials, a stable discharging amount, or a stable coating amount, by increasing a flow rate of the liquid such as all the slurry by using a piping having a larger diameter in which a flow rate is higher than that in the flow passage of the discharging device or the like to prevent sedimentation of liquid such as slurry in the container.

As described above, since not only handling of small amounts of materials for experimental devices such as materials for pharmaceutical research, electrode inks for fuel cells, and slurries for electrodes of next generation batteries such as all-solid battery but also handling, discharging, coating, or the like of large amounts of materials for each production can be performed, consistent data can be used, and performance does not matter.

### BRIEF DESCRIPTION OF DRAWINGS

FIG. 1 is a schematic cross-sectional view showing a container communicated to a discharging device among at least two containers, liquid flow passages, and a constitution of a gas piping for pressurization, relating to the embodiment of the present invention.

FIG. 2 is a schematic cross-sectional view showing a reserve container for handling a backflow and an intake/exhaust structure of a compressed gas, relating to the embodiment of the present invention.

FIG. 3 is a schematic cross-sectional view of a container relating to the embodiment of the present invention, wherein a container size is optional, and a protector for preventing backflow at an upper part of the container filled with liquid is mounted.

FIG. 4 is a schematic cross-sectional view showing a state where a flow passage having a large piping diameter other than a flow passage of a discharging or coating device between two containers is provided.

FIG. 5 is a schematic cross-sectional view of the container showing how a swirling flow of liquid is formed at a bottom of the container.

### DETAILED DESCRIPTION

Hereinafter, preferable embodiments of the present invention will be explained with reference to the drawings. It should be noted that the following embodiments are examples to facilitate understanding of the invention, and additions, substitutions, modifications, and the like performed by those skilled in the art are not excluded within the scope of the technical concept of the present invention.

The drawings schematically show preferable embodiments of the present invention.

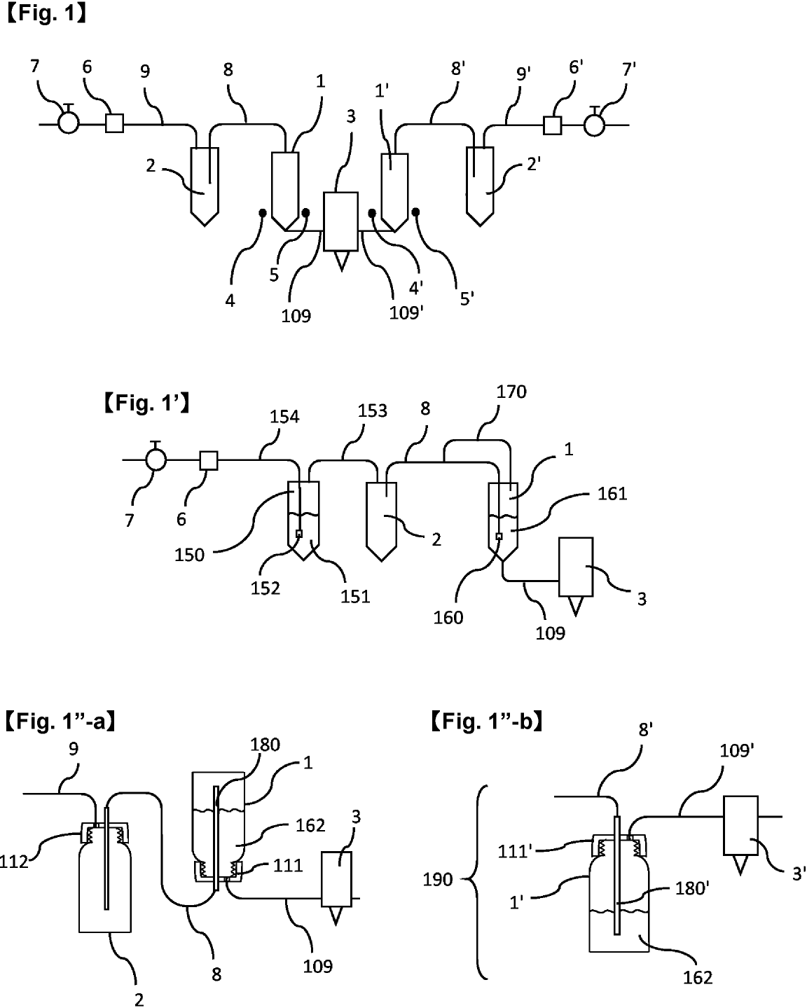

In FIG. 1, the embodiment is explained by regarding one of the containers as a first container and the other container as a second container. The first container 1 is connected to the second container 1′ via a discharging device 3 connected by a flow passage 109 and further via a flow passage 109′. An extended gas flow passage is inserted deeply from the upper part of the second container 1′ into a reserve container 2′ via an upper part of the reserve container 2′ via a gas piping 8′. The upper part of the reserve container 2′ is connected to an automatic switching valve 6′ through a piping 9′. A compressed gas flows in from the upper part of the second container 1′ via a regulator 7′ and via the second reserve container 2′ after the automatic switching valve 6′ is put ON, which pressurize unshown liquid being filled in the second container 1′, the liquid is transferred at a high speed via a liquid flow passage 109′, inside of the discharging device 3, and a flow passage 109, and flows into the container 1 via a lower part thereof, by which the liquid is filled. In this case, since the automatic switching valve 6 is OFF, an exhaust port of the automatic switching valve 6 is communicated to the first container 1 via a piping 8, a reserve container 2, and a piping 9, by which the liquid is transferred toward the upper part of the container 1 due to an atmospheric pressure. It should be noted that a material for sealing a moving spool to switch the switching valve 6, the compressed gas flow passage, and the exhaust port is preferably a metal seal, a ceramics seal, a fluorocarbon resin, or a coating member therefor, which has low sliding resistance and is not swollen by solvent vapor. An automatic switching valve 6′ is put OFF by an unshown controller when an unshown liquid surface of the second container 1′ reaches near a vicinity of level sensors 4′ and 5′, the second container 1′ is exposed to an atmospheric pressure, and the automatic switching valve is put ON, by which a compressed gas regulated by a regulator 7 pressurizes an unshown liquid surface of the first container 1. When the liquid surface descends and reaches the vicinity of level sensors 4′ and 5′ of the first container 1, it is detected to operate the automatic switching valve 6 and 6′ by an unshown controller, by which liquid in flow passages 109 and 109′ is automatically inverted and transferred. By repeating this inversion, transfer such as continuous circulation is repeated, and liquid is discharged or coated by a discharging device 3. Even if liquid flows back to reserve containers 2 and 2′ through pipings 8 and 8′, since a compressed gas piping flow passage extends toward a lower part of the reserve container and is largely separated from an upper part of the reserve container by a space inside the container, and liquid falls by its own weight, liquid filled with a volume smaller than those of the reserve containers 2 and 2′ does not flow back to the automatic switching valves 6 and 6′. If fine particles of liquid are generated, particles and the like that enter the upper part of the reserve container can be blocked by setting a breathable nonwoven fabric sheet or screen, or the like. Furthermore, if an expensive slurry or the like flows back, it can be easily recycled by removing an unshown cap under the reserve container or by opening a small cock or the like. If the liquid in the container cannot be detected due to transparent material such as PFA and PP, an ultrasonic sensor or the like can be used to detect the liquid level.

FIG. 1′ is an example of the present invention, where bubbles are mixed into liquid such as slurry to prevent sedimentation of solid particles and the like by using bubble effects, a piping for a compressed gas is inserted into the lower part of the container 1 (near an inlet/outlet of liquid) to stabilize dispersion, and a bubble generator 160 is provided beyond that, thereby mixing bubbles into liquid 161. The piping 8 is inserted into the inside of the reserve container 2, and if liquid flows back, it can be stored in the container 2. In the present invention, there may or may not be a solvent bubbler container 150 that generates bubbles humidified with solvent vapor. Also, the piping 8 is branched on the midway such that a piping 170 is connected to the upper part of the first container, thereby enabling to pressurize liquid 161. Keeping a balance with a flow rate in the bubble generator 160, the flow rate in the piping 170 can be adjusted with a flow regulator, a fixed orifice, or the like that is not shown in FIG. 1′. The upper part of the reserve container 2 is connected to the upper part of the solvent bubbler container 150 via a piping 153. The inside of the solvent 151 filled in the solvent bubbler container 150 is connected to the automatic switching valve 6 by a piping 154 via the upper part of the bubbler container 150, and there is a compressed gas regulator 7 at the upper stream. Solvent vapor is generated in the bubbler container 150 when the solvent is pressurized with a compressed gas, and the solvent vapor is mixed into the inside of the bubbles of the liquid 161, to minimize volatilization of the solvent in the liquid. It should be noted that the upper part of the opposite liquid container, which is not shown in FIG. 1′, has the same configuration and therefore the explanation thereof will be omitted.

Similarly, FIG. 1″-a is an example of the present invention. The liquid container and the reserve container may be made, but can be provided by inexpensively making or modifying a commercially available containers such as bottles, especially lids of glass or plastic containers such as bottles having a wide mouth lid. In a case that a lid 111 of the container 1, which is commercially available and transparent or semi-transparent, is processed to provide a flow passage for the liquid and the compressed gas, a gas flow passage 180 reaches the vicinity of the bottom of the container 1.

A reaching position of the compressed gas flow passage port can be adjusted freely, depending on a liquid surface. The flow passage may be extended by fixing the piping 8 such as a PFA tube at the middle of the connector that is not shown in FIG. 1″-a, and another piping may be provided. Besides, a means leading to the liquid flow passage such as a connector that fixes PFA or the like having a chemical resistance can be attached to the lid 111. The lid may be made specially. The type of the container or lid for filling liquid is not limited to PP, PE, PFA, metal, glass, ceramics, or the like, but PFA is preferred in terms of chemical resistance and easy releasing of liquid. Since the container 2 may be disposable, an inexpensive PP or PE container can be selected. Since the structure of the upper part (the lid) is the same as that shown in FIG. 1, the explanation thereof will be omitted. Since the pressure of the compressed gas may be 100 kPa or lower and 50 kPa or lower as well, a commercially available container has no problem in terms of pressure resistance. FIG. 1″-b shows a posture 190 in filling liquid. The desired amount of liquid is filled by removing a lid 111′. When the lid is closed and the container is inverted, the posture shown in FIG. 1″-a is realized. The liquid that flowed into a piping 180 can be pushed out into the container by manually or automatically putting ON instantaneously a flow passage leading to the compressed gas piping 8.

It should be noted that the inner diameters of the tube and the pipings are preferably small, for example, smaller than 2 mm, to minimize the amount of liquid inside the piping 180 and the gas piping 8 in inverting the container. Furthermore, the bottom of the reserve container 2 is preferably above the liquid level of the liquid in the container to minimize liquid inflow into the gas piping.

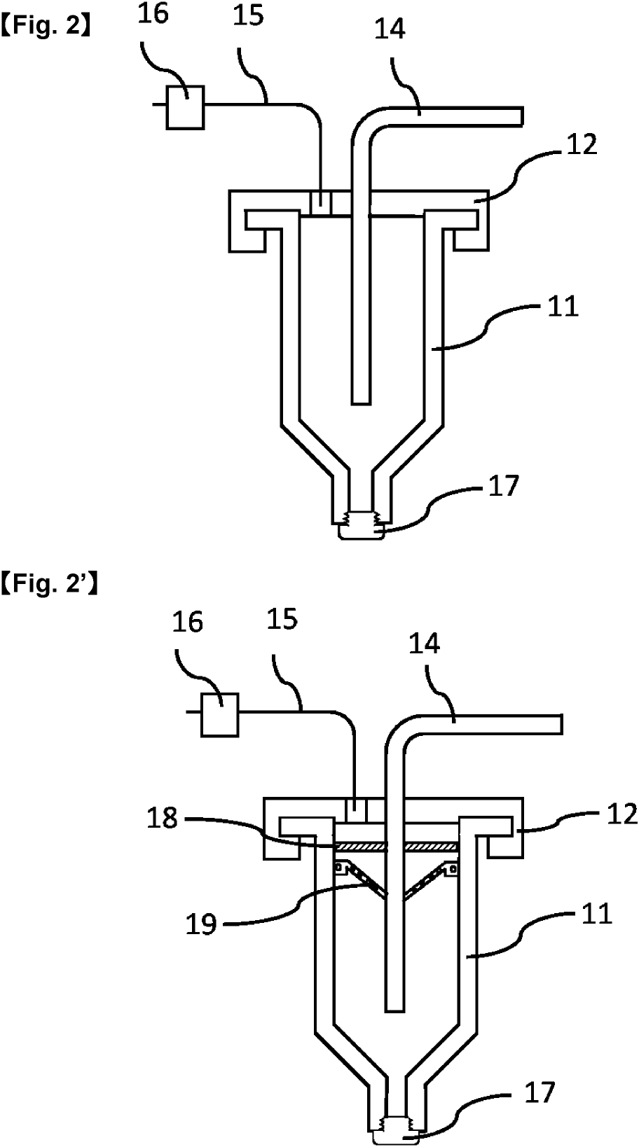

FIG. 2 is an enlarged view of the reserve container 2 in FIG. 1, where an exhaust (compressed gas) piping (tube) 14 leading from the container filled with liquid is inserted through the connector for setting an unshown piping of an upper adapter 12 of the reserve container 11 and into the reserve container 11. The piping inserted into the reserve container 11 may be provided with another flow passage such as a piping. It is enough that the insertion position of the inserted piping or the like is determined based on a liquid property and is near the upper part 12 of the reserve container 11, for example, at the position of ⅕ to ¼ from the upper part. When the specific gravity is small or viscosity is low, the insertion position is at the position of ⅓ from the upper part of the reserve container or deeper. If the unshown liquid in the reserve container that flowed back can be easily recycled by opening a simple cock attached to the lower part of the unshown reserve container, by removing a plug 17 or the like, or by doing something like these.

FIG. 2′ shows a strict preventive measure against a backflow of the liquid that has low viscosity and is prone to be easily turned into droplets by less energy. Fine droplets can also be removed by providing, for example, an inexpensive non-woven fabric on the upper part, such as a screen 18 that is a net or the like, to prevent a backflow of droplets or liquid by the component and the protector 19, the component being in contact with an inner periphery and has a hole near an outer periphery. There is a need to carefully consider the desired number of holes of the component in contact with the protector, and a selection of porous base materials of the screen, the non-woven fabric, or the like, because they affect a moving speed of a compressed gas or an exhaust for each application.

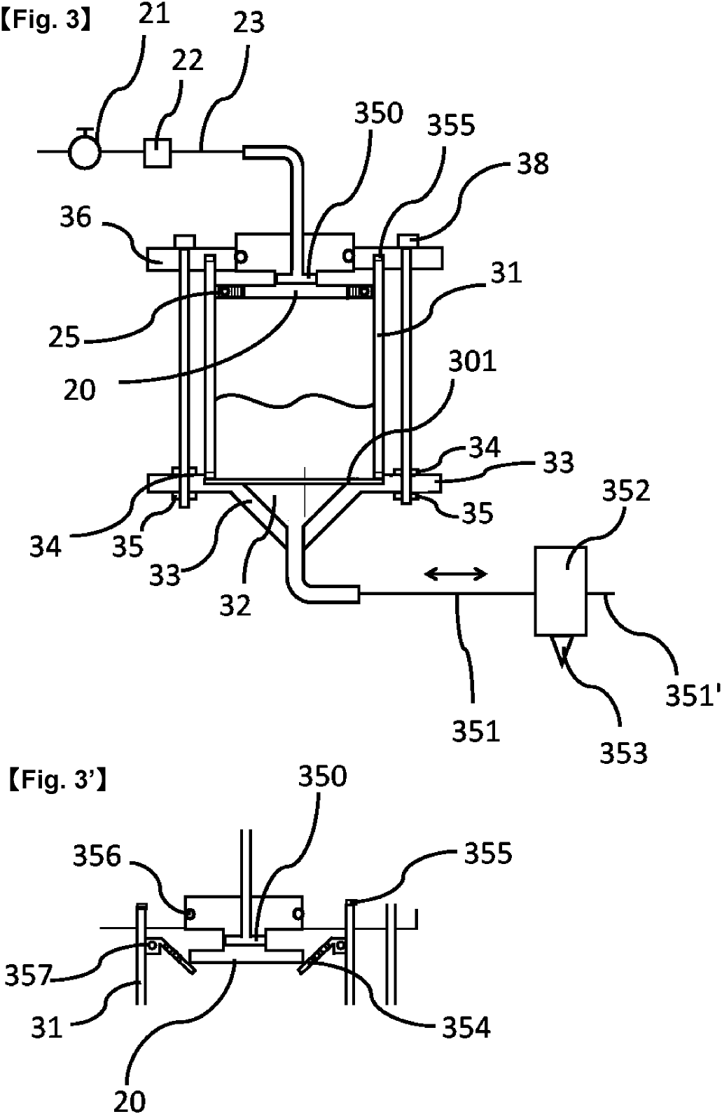

FIG. 3 shows that the container to be filled with liquid 32 can be made as a container assembly and used. It can be made in a desired size to fit the discharging device. It has also an advantage as a structure because a desired member and the like can be attached thereto. In addition, since it can be easily disassembled and assembled, it is particularly effective in cleaning a contact surface. An upper lid 36, a tube 31 that is made of a transparent, semi-transparent, or metal material such as PFA, PP, and tempered glass, and a lower lid 33 are fixed by fastening with a bolt 38, a nut 34, and a nut 35. The upper lid 36 may be fixed by setting the bolt 38 from the lower lid to the upper lid, as opposite to FIG. 3, and by fastening it with nuts 34 and 35. Instead of the bolt, a long screw can be used to sandwich the upper and lower lids with nuts from both sides as with the lower lid and to fasten them appropriately. The upper and lower lids may be made of a plastic such as PEEK and PFA, or metal. A seal 355 between both ends of the transparent tube 31 and the upper and lower lids 33 and 36 has desirably a chemical resistance, and may be an O-ring or a PTFE ring. A complete seal for a pressurized compressed gas or liquid can be made by fastening it with the nut 35 and by fixing it with the nut 34. The seal of the upper lid, which may handle a compressed gas, may be an O-ring such as NBA and Viton, but a seal of the lower lid is preferably a PTFE gasket, or an O-ring made of perfluoro ethylene or the like, which does not swell in a solvent or the like. This is the basic of the container assembly, and can be utilized as a container assembly of the present invention or the inventions other than the present invention. If the tube is made of metal or ceramics particularly for an application of melted bodies, an inner surface can be honing-processed to increase an accuracy, enabling to easily perform mirror finishing or the like. A tube shape should be hollow but is not particularly limited. It may be a square, polygon, or ellipse. The upper and lower lids or a seal may be processed depending on the shape.

Since the container of the present invention can be disassembled and assembled, countermeasure components can be set inside thereof. For example, the upper lid 36 of the container can be provided with an opening for filling liquid. In other words, the upper lid can be plugged. Besides, an opening on the opposite side of the plug can be used to fill liquid, and the plug can also be used as a reflector 20 to splash liquid and droplets that flow back. A backflow of a material having high specific gravity and relatively high viscosity, and a backflow of liquid and droplets can be easily prevented only by this. For this reason, a flow passage 350 of a compressed gas can be provided at the deep position of the backside of the tip of the reflector 20 to prevent liquid inflow. Furthermore, with the reflector 20 set in place, a hollow porous disk 25 for filling the space between the outer periphery of the reflector and the inner periphery of the container tube 31 can be provided.

On the other hand, the filter screen 301 can be set on the lower lid 33, and the seal 355 can be set thereabove, or thereabove and therebelow, and the tube 31 can be fastened with the bolt 38 and the nut 35 and finally fixed with the nut 34. The size of the opening of the filter screen 301 can be selected from 2/1000 to 20/1000 inches, based on the size or shape of the particles or short fibers in the slurry, and the size of the agglomerates of the slurry. The shape of the opening is not limited. The size may be smaller or larger than that, and may be 1 mm. The filter screen is effective for not only filtration but also dispersion of slurry and the like because liquid pressure is applied.

FIG. 3′ further shows a method for easily eliminating a need for the reserve tank. It can be proposed as the method that a screen assembly 354 having a hollow middle part is attached to the upper part of the tube, and an O-ring 357 is attached and fixed between that and the tube. The tip of the protector 20 is set to push the screen 354. Droplets are completely blocked by this, enabling a compressed gas or an exhaust to be transferred via the screen around the protector. The screen may be made of an inexpensive non-woven fabric and is not particularly limited if it has a breathability and no influence on a liquid pressure and an exhaust speed.

Of course, the container can be used effectively as a liquid container without providing countermeasures against backflows.

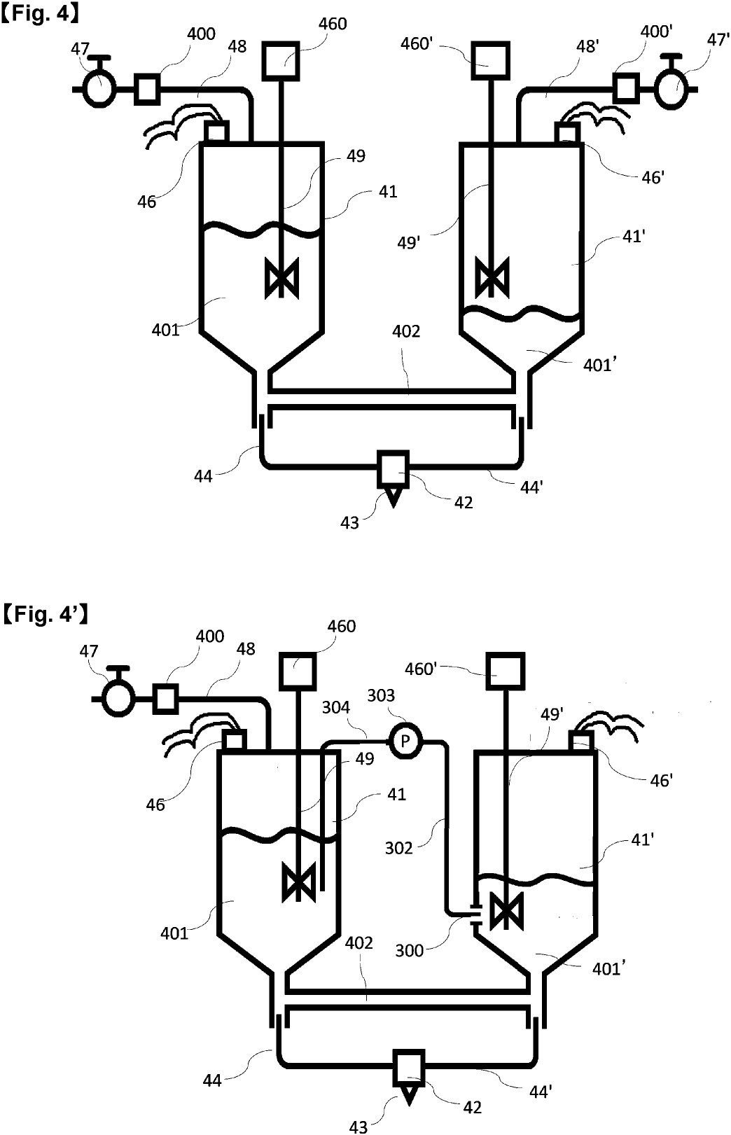

In FIG. 4, since the liquid 401′ such as slurry, which was filled in a relatively large container 41′, is pressurized by connecting the inside of the container 41′ with the compressed gas regulator 47′ by putting ON the automatic switching valve 400′, the liquid is transferred into the container 41 via the flow passages 44′ and 44. In the present invention, another flow passage 402 that communicate the container 41 to the container 41′ can be provided to increase the amount of transfer per unit time of the liquid 401 and the liquid 401′ in the containers. The shorter the flow passage 402 is, the better it is, as it offers less resistance for a higher flow rate. In that case, it does not matter how large or small the inner diameter is. The inner diameter can be made large in a desired size particularly if the passage needs to be long to increase a transfer speed of the liquid 401′ in the container 41′. One of or a plurality of unshown flow rate adjusting valves or the like may be provided in the middle of the flow passage or at a desired position. Another flow passage 402 may a plurality of passages. The flow passage may be branched into multiple flow passages.

Liquid transfer can be switched automatically by detecting the liquid surface with an unshown sensor or the like at the lower part of the container and by operating the automatic switching valves 400 and 400′ in the compressed gas lines with a similarly unshown controller. Of course, it can be switched by time with a timer. Time adjustment may be done in 0.1 or 0.001 second increments and is not limited. One compressed gas regulator may be branched, or as shown in FIG. 4, two regulators may be used to fine-tune subtle variations of individual resistances or the like for making the amounts of transfers per unit time the same as each other. Operation of transfer, coating, and the like are the same as those shown in FIG. 1.

In the present invention, particularly if the size of the container is large, agitating devices 460 and 460′ can be provided. For example, blades of the agitating device can also be rotated when the liquid level is equal to or above the blade level. In the present invention, a part of the lid of the container can be made of tempered glass and be provided with sensors 46 and 46′ to detect the level from outside the container.

FIG. 4′ shows that the liquid 401 in the container 41 is transferred via the flow passages 44, 44′, and 402 to the container 41′, in which the pressure inside thereof is an atmospheric pressure or lower than that in the container 41, by pressurization with a compressed gas, and a continuous circulatory circuit can be formed by suctioning the liquid with the pump 303 from the container outlet 300 via the piping 302, by pressurizing it, and by transferring it to the container 41, when the level of the liquid 401′ is at a desired level. The above-mentioned flow passage 402 and the flow passage 44′ via the discharging device can transfer liquid by setting the piping outlet at the desired position of the container 41′ from the lowest part or the desired lower part of the container 41, or at the desired position inside the container 41′ via the upper lid or the like, using piping and the like. In this case, in addition to the above-mentioned container outlet 301, a suction piping leading to the pump may also be at the desired position, for example, may be set from the lowest part of the container 41′. Furthermore, the liquid can be transferred by pressurization to the desired position of the container 41 through the piping, the position being the destination of pressure feeding. It can be pressure-fed from the inside of the container 41′ to the desired position of the one of the containers 41 via the upper lid and the like. In the case that mixing of bubbles into not only the liquid from the outlet of the pressure-feeding line of the piping or the like leading from the container 41 but also the liquid from the pressure-feeding line of the piping or the like leading from the pump are disliked, the liquid is preferably flowed out along the inner wall of the container to prevent the mixing of gases. Since such a configuration enables the liquid pressure fluctuation to be completely isolated, the liquid pressures in the flow passages 41 and 41′ leading to the discharging device are not influenced at all. The pump may be operated continuously or intermittently. In this method, since the liquid is pressurized with a precisely controlled compressed gas and almost no pulsation occurs up to the discharging device, and since the large area of the liquid inside the other container is in contact with, for example, an atmospheric pressure, and therefore no pulsation problem exists near the discharging device, the liquid pump such as a plunger pump, a snake pump, a gear pump, a tube pump, and a diaphragm pump may be used. The liquid pressure near the discharging device can be made constant since the pressures of the liquid and the compressed gas in the flow passage 44 or in the discharging device can be made constant by using a precise regulator having a high precision relief. Pulsation may occur when using the pump such as the above-mentioned diaphragm pump, and an inexpensive pump such as an intermittently feeding single plunger pump may be used. In particular, in the case that solid content is sedimented in the container, the liquid transfer speeds in the flow passage 402 and the container need to be increased. When the liquid surface in the container 41′ reached below the desired liquid surface, it may be detected by an unshown sensor or the like of the container 41′ to stop the pump automatically, and the lower limit liquid level in the container 41 can also detected to fill liquid having the amount used in the liquid discharging device or the like. The transfer flow rate by pump can be determined or adjusted according to the transfer flow rate in the container or the transfer amounts in the flow passages 44, 44′, and 402 to perform circulation always in a stable condition. Of course, in the present invention, the same reserve container as in FIG. 1 can be provided upstream of the large container, even if the large container is used. The compressed gas can be humidified by the solvent bubbler or the like.

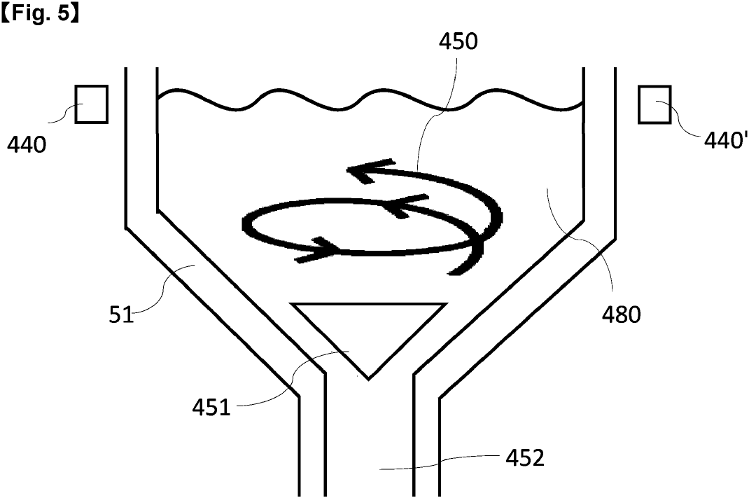

FIG. 5 shows that a dispersing means such as a dispersing implement 451 such as a liquid jetting means and a swirling flow is provided. An unshown filter screen, which has a dispersion assisting effect and is used for filtration, may be provided instead of or jointly with the dispersing implement 451. The filter screen may be provided at the upper or lower stream of the dispersion implement.

The lower part of the container 51 is desirably tapered or bowl-shaped such that liquid is transferred smoothly without stagnation. The dispersion method may be provided at any individual point near the position from the lower part of the container to the container inlet/outlet 452. The swirling flow 450 of the liquid in the flow passage can be large or small, and strong or weak, depending on the shape of the swirling means. In particular, when the liquid is switched or the liquid level is low to the extent that the own weight is low, slurries or the like can be ideally mixed and dispersed. This method is effective even if the diameter of the container is large.

Furthermore, the level can be detected with the sensors 440 and 440′ for emitting and receiving light by enabling the light to pass through at least a part of the container near the lower limit of the liquid surface at the time of liquid descending, which is near the lower part of the container 51, to detect the level. An organic solvent may be used for the solvent for slurry. In the case of using the liquid container in a booth, a sensor for emitting and receiving light, which uses an optical fiber and does not need an electrical wiring, may be used. If roughly switching is enough, switching the liquid transfer may be performed by time without using sensors. A minimum unit adjustment of 0.1 or 0.001 seconds can be performed timewise. The switching time of the two containers can also be adjusted subtly by enabling to set a desired time.

In the present invention, an extremely small amount of liquid such as slurry can be discharged or sprayed with at least an inkjet or dispenser while dispersing the liquid by using small containers or the like. Besides, an object can be coated with at least a small inkjet, dispenser, spraying device, slot nozzle device, or the like.

On the other hand, in the present invention, a large amount of liquid such as slurry can be discharged, sprayed, or coated with at least one of the inkjet, the dispenser, the spraying device, and the slot nozzle device for production by using a large container, enabling handling of a production line and mass production as well.

According to the present invention, in the case of using a small amount of liquid such as slurry for experiments and the like such as granulation of pharmaceuticals and electrode formation for next-generation batteries, or in the case of using a large amount of liquid on the large-scale production line therefor to produce products, manufacturing can be performed in high quality.

Reference Sign List

| | |
|---|---|
| 1, 1′, 41, 41′,51 | Container |
| 2,2′,11 | Reserve container |
| 3, 42, 352 | Discharging (coating) device |
| 43,353 | Nozzle |
| 4, 4′, 5, 5′, 46, 46′, 440, 440′ | Level sensor |
| 6, 6′, 16, 22, 400, 400′ | Automatic switching valve |
| 7, 7′, 21, 47, 47′ | Compressed gas regulator |
| 8,8′,9,9′,14,15,23,48,48′,153,154,170 | Compressed gas piping |
| 12 | Container lid |
| 17 | Plug |
| 18 | Screen |
| 19 | Breathable reflector |
| 20 | Reflector |
| 25 | Ventilation hole part |
| 31 | Tube |
| 32,161,401,401′,480 | Liquid |
| 33 | Lower lid |
| 34,35 | Nut |
| 36 | Upper lid |
| 38 | Bolt |
| 43 | Nozzle |
| 44,44′,109,109′,302,304,351,351′ | Liquid piping |
| 150 | Bubbler container |
| 151 | Solvent |
| 152 | Bubble generator (solvent) |
| 160 | Bubble generator (liquid) |
| 300 | Container outlet |
| 301 | Filter screen |
| 303 | Pump |
| 350 | Inlet/outlet of compressed gas |
| 354 | Screen |
| 355 | Seal |
| 356, 357 | O-ring |
| 402 | Another flow passage (liquid) |
| 450 | Swirling flow |
| 451 | Dispersing implement |
| 452 | Container inlet/outlet flow passage |
| 460, 460′ | Agitating device |

1. A method for discharging or coating liquid, comprising:
providing the device for discharging or coating the liquid among at least two containers,
communicating the containers with the device for discharging or coating the liquid via a liquid flow passage,
pressurizing the liquid filled in at least one of the containers to generate a differential pressure between the one of the containers and another container,
transferring the liquid in the flow passage,
reversing the differential pressure between the containers near a lower limit of liquid surface in the one of the containers to perform inverted transfer of the liquid between the containers automatically and repeatedly, and
providing a reserve container having a larger volume than at least a total volume of the liquid at an upper stream of each of the containers to store in the reserve container the liquid that flows back to a reserve container for preventing a backflow of the liquid or droplets of the liquid to an upper stream of the reserve container.

2. The method for discharging or coating the liquid of claim 1, further comprising:
extending compressed gas flow passages into both the containers via lids,
connecting liquid flow passage pipings to the lids,
inverting the containers after the container lids are removed and filled with the liquid,
positioning each outlet of the compressed gas flow passages upstream of each liquid surface,
pushing out the liquid inside the compressed gas flow passages,
pressurizing the liquid coming from the outlet of the compressed gas flow passages by a compressed gas, and
transferring the liquid by a pressure of the compressed gas via the liquid flow passages from one of the containers to the other container.

3. The method for discharging or coating the liquid of claim 1, further comprising:
pressurizing the liquid in the container by the compressed gas,
providing an automatic switching valve having an inflow port and an exhaust port of the compressed gas upstream of the reserve container,
connecting a piping for the compressed gas to make the compressed gas exhaust enter the reserve container via an upper part of the container and an upper part of the reserve container and
connecting the piping from a compressed gas inlet or outlet provided at another position on the upper part of the reserve container to the automatic switching valve for the compressed gas.

4. The method for discharging or coating the liquid of claim 1, further comprising:
detecting a lower limit of a liquid level at a lower part of the container on a side in which the liquid descends,
increasing at least a flow velocity in the liquid flow passage,
controlling the level to repeat liquid transfer near the lower limit of the liquid level of the container and reverse the container automatically, and
generating a swirling flow or jet of the liquid in the lower part of the container on a side in which the liquid flows in, at least in switching the liquid transfer, to improve liquid dispersion.

5. The method for discharging or coating the liquid of claim 4, further comprising:
setting an average diameter of the liquid flow passage between the containers to 1.5 to 4.0 mm, and
setting a liquid speed inside the flow passage to 0.4 m/s or more.

6. The method for discharging or coating the liquid of claim 5, further comprising:
filling the container with the slurry or dispersion having a low viscosity of 500 mPa s or less as the liquid, the container having the lower part that is invertedly widened, bowl-shaped, or in a similar shape, and
generating the swirling flow or jet of the liquid in switching transfer between the containers.

7. The method for discharging or coating the liquid of claim 6, further comprising:
floating a ball on the liquid surface to prevent at least droplets generated by the swirling flow or jet from flowing back to the compressed gas passage at the upper part of the container.

8. The method for discharging or coating the liquid of claim 7, further comprising:
putting a total volume of the liquid equal to or smaller than an internal volume of the one of the containers,
providing a protector at a compressed gas inlet port on the upper part of the container to intrude into the container, the protector having breathability at least partially and blocking the liquid transfer, and
preventing the liquid or droplets from flowing back by the protector.

9. A method for discharging or coating liquid, comprising:
providing the device for discharging or coating the liquid among at least two containers,
communicating the containers with the device for discharging or coating the liquid via a liquid flow passage,
pressurizing the liquid filled in at least one of the containers to generate a differential pressure between the one of the containers and another container,
transferring the liquid in the flow passage,
reversing the differential pressure between the containers near a lower limit of liquid surface in the one of the containers to perform inverted transfer of the liquid between the containers automatically and repeatedly, and
increasing a transfer speed of the liquid in the container by providing another passage such that a flow rate therein is higher than that in the flow passage.

10. A method for discharging or coating liquid, comprising
pressurizing at least one of containers with a compressed gas,
pressuring liquid filled in one of the containers to transfer the liquid via a plurality of liquid flow passages to the other container in which a pressure is lower than an atmospheric pressure or a pressure in the other container,
detecting liquid levels of the both containers,
suctioning and pressurizing the liquid in the other container by pump to form a circulatory circuit by putting the liquid back to the one of the containers,
increasing a liquid transfer speed, and
maintaining at least a liquid pressure of the discharging device constant at any time.
